(19) United States
(12) Patent Application Publication
(10) Pub. No.: US 2008/0285787 A1
(43) Pub. Date: Nov. 20, 2008

(54) THIN LOUDSPEAKER

(76) Inventor: Sun Szu-Wei, Gueishan Township (TW)

Correspondence Address: Alan D. Kamrath;Kamrath & Associates, P.A., Suite 245, 4825 Olson Memorial Highway, Golden Valley, MN, 55422, US

(21) Appl. No.: 11/749,871

(22) Filed: May 17, 2007

(51) Int. Cl. H04R 9/06

(52) U.S. Cl. 381/409; 381/398

(57) ABSTRACT

In one embodiment a loudspeaker includes a cylindrical, staged frame; an annular voice coil having coil wires mounted on a lower portion; an annular U type spaced around the voice coil and secured to a bottom of the frame, the U type including radial channels; a magnet on a center of the voice coil; a damper secured to the frame; a bridge including arms through the channels, the arms being secured between the voice coil and the damper; and a cone secured between a top of the frame and the voice coil above the coil wires. This construction can lower the center of gravity of the voice coil so that the loudspeaker can be made thin. Also, the voice coil is more stable when the loudspeaker is activating.

### BACKGROUND OF THE INVENTION

1. Field of Invention

The invention relates to loudspeakers and more particularly to a thin type of loudspeaker.

2. Description of Related Art

A conventional loudspeaker is shown in FIG. 1 and comprises a truncated, conic frame 11, a central U type 10 mounted under a bottom opening of the frame 11, a magnet (e.g., permanent magnet) 12 provided on the U type 10, a washer 13 provided on the magnet 12, a voice coil 14 provided around the washer 13 and having coil wires 141 wound around its lower portion, a damper 15 secured around the remaining portions of the voice coil 14, and a cone 16 having a bottom secured to a top edge of the voice coil 14, the cone 16 having a convex top edge 17 proximate a peripheral edge of the loudspeaker.

The damper 15 and the edge 17 together can prevent the vibrating voice coil 14 from contacting one or more of the U type 10, the magnet 12, and the washer 13 when the loudspeaker is activating. However, the voice coil 14 is required to have a sufficient height in order to preserve space (i.e., its intermediate and upper portions) for securing to the damper 15. This inevitably will increase thickness of the loudspeaker. Otherwise, it is impossible of mounting the voice coil 14 in the loudspeaker. Moreover, the mounting of the damper 15 above the coil wires 141 can increase height of the center of gravity of the voice coil 14. As such, the voice coil 14 tends to vibrate during activation, resulting in a lowering of the performance of the loudspeaker.

Another conventional loudspeaker is shown in FIG. 2 in which a damper 20 disposed in an internal space of a U type 22 having a peripheral inner edge secured to a peripheral bottom edge of coil wires 211 of a voice coil 21 and a peripheral outer edge secured to a peripheral shoulder 222 of the U type 22. This construction can decrease height of the voice coil 21, resulting in a decrease of thickness of the loudspeaker. Further, the voice coil 21 is securely mounted because the damper 20 is disposed around a bottom of the voice coil 21. But the extent of the thickness decrease of the loudspeaker is unsatisfactory. Thus, the need for improvement still exists.

### SUMMARY OF THE INVENTION

It is therefore one object of the invention to provide a thin loudspeaker by connecting radial arms of a bridge to lower coil wires of a voice coil and disposing a damper externally of an annular U type in which the damper is secured to a frame. By utilizing the invention, the center of gravity of the voice coil is lowered greatly and is more stable when the loudspeaker is activating so as to improve sound quality of the loudspeaker.

The above and other objects, features and advantages of the invention will become apparent from the following detailed description taken with the accompanying drawings.

### BRIEF DESCRIPTION OF THE DRAWINGS

FIG. 1 is a cross sectional view of a conventional loudspeaker;

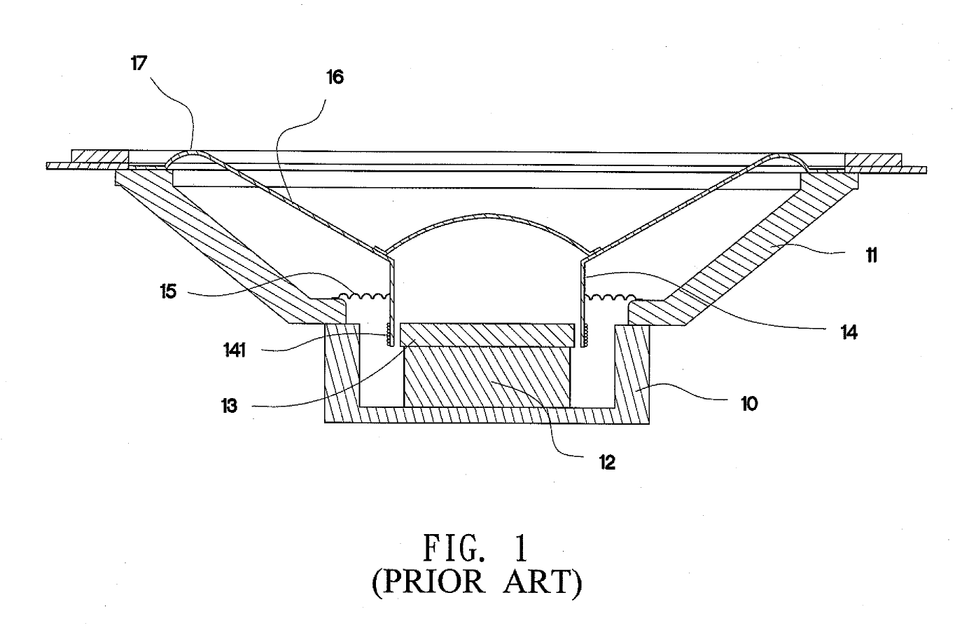

FIG. 2 is a cross sectional view of another conventional loudspeaker;

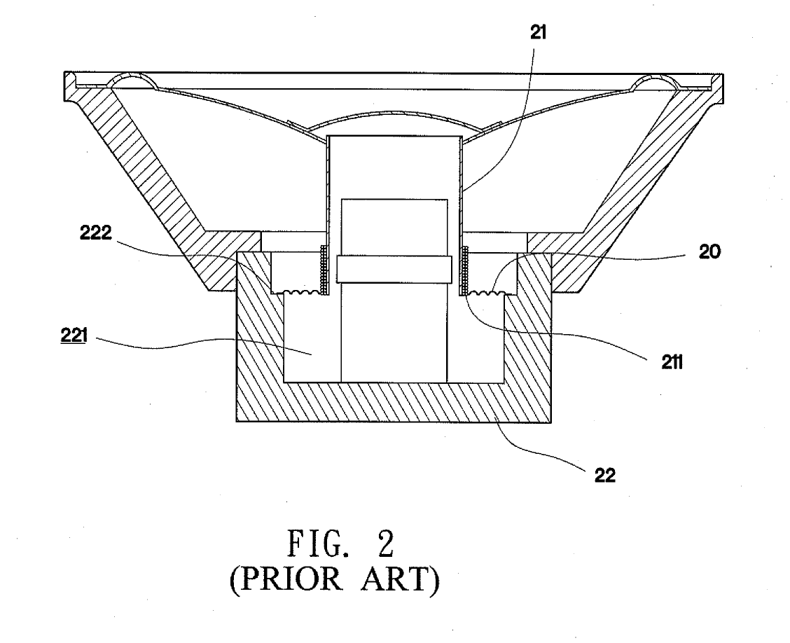

FIG. 3 is a cross sectional view of a first preferred embodiment of loudspeaker according to the invention;

FIG. 4 is a schematic perspective view of the loudspeaker shown in FIG. 3; and

FIG. 5 is a cross sectional view of a second preferred embodiment of loudspeaker according to the invention.

### DETAILED DESCRIPTION OF THE INVENTION

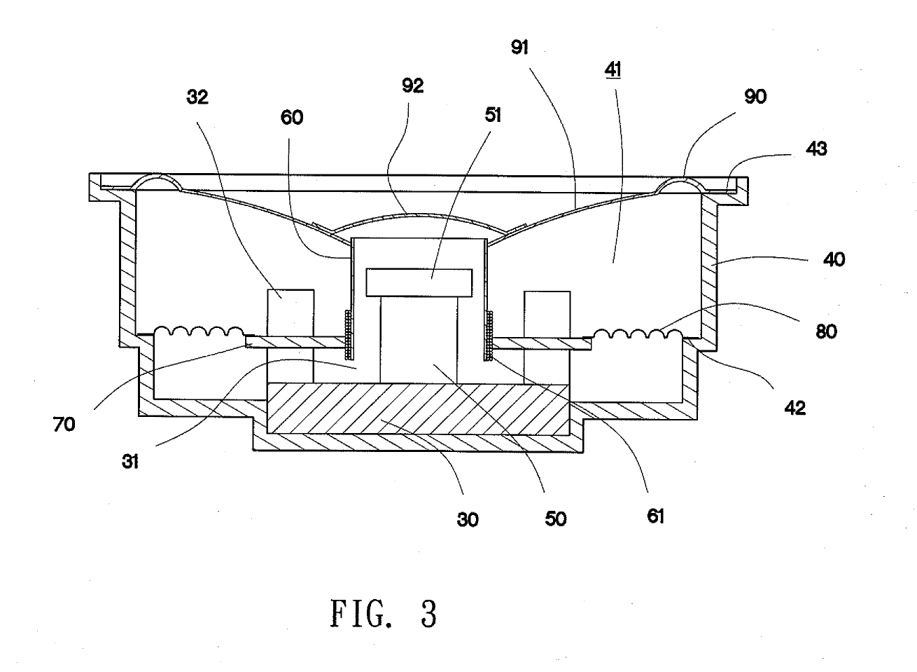

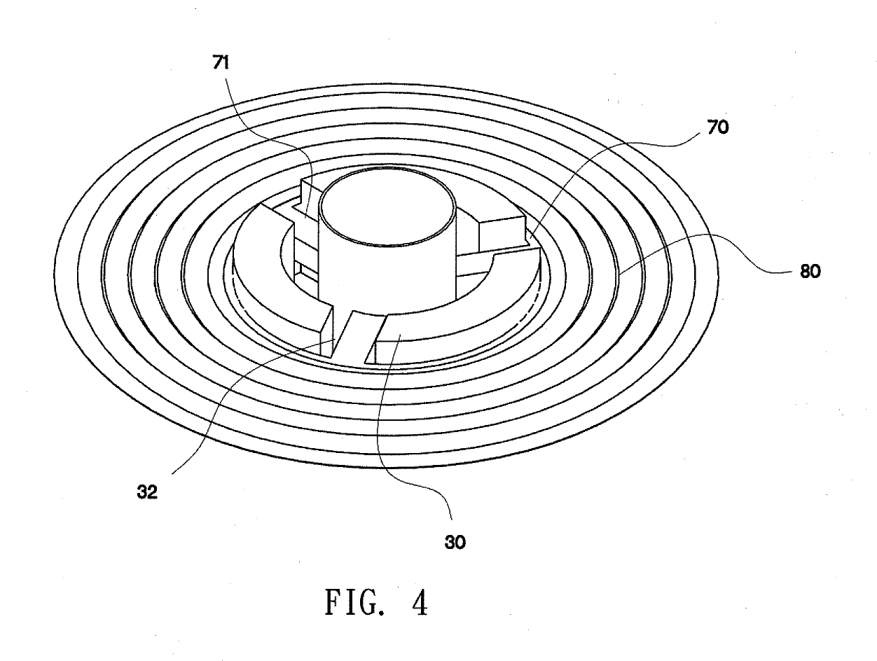

Referring to FIGS. 3 and 4, a loudspeaker in accordance with a first preferred embodiment of the invention is shown. The loudspeaker comprises a plurality of components as discussed in detail below.

A substantially cylindrical, short frame 40 is provided. An annular U type 30 is disposed on a bottom cavity (not numbered) of a staged space 41 defined by the frame 40. A space 31 is defined by the U type 30. The U type 30 comprises a plurality of equally spaced radial channels 32. A magnet (e.g., permanent magnet) 50 is provided on a center of the cavity with the U type 30 around. A washer 51 is provided on the magnet 50.

A hollow, cylindrical voice coil 60 is provided around the washer 51 and spaced therefrom. The voice coil 60 has coil wires 61 wound around its lower portion. Heatproof adhesive is coated on the coil wires 61. A bridge 70 has three arms 71 having one end secured to the coil wires 61. The arm 71 extends from an intermediate portion of the circumferential surface of the coil wires 61 to dispose externally of the U type 30 by passing the channel 32. Further, a circle (not numbered) is formed around the U type 30 and is integrally formed with outer ends of the arms 71. The circle is secured to a circumferential inner edge of a damper 80. A circumferential outer edge of the damper 80 is secured to a circumferential shoulder 42 of the frame 40.

The frame 40 has a circumferential top edge 43 secured to a convex, circumferential top edge 90 of a cone 91. A circumferential top edge of the voice coil 60 is secured to a circumferential inner edge of the cone 91 (i.e., secured at a position above the coil wires 61). A convex dust cap 92 is provided on a central portion of the cone 91 above the voice coil 60.

By configuring as above, the voice coil 60 is secured by the cone 91, the bridge 70, the damper 80, and the frame 40. Also, the bridge 70 is secured to the coil wires 61. Hence, the center of gravity of the voice coil 60 is lowered and is thus more stable when the loudspeaker is activating. As a result, sound quality of the loudspeaker is improved significantly. Moreover, the damper 80 is disposed externally of the U type 30, resulting in a possibility of making a thin loudspeaker as envisaged by the invention.

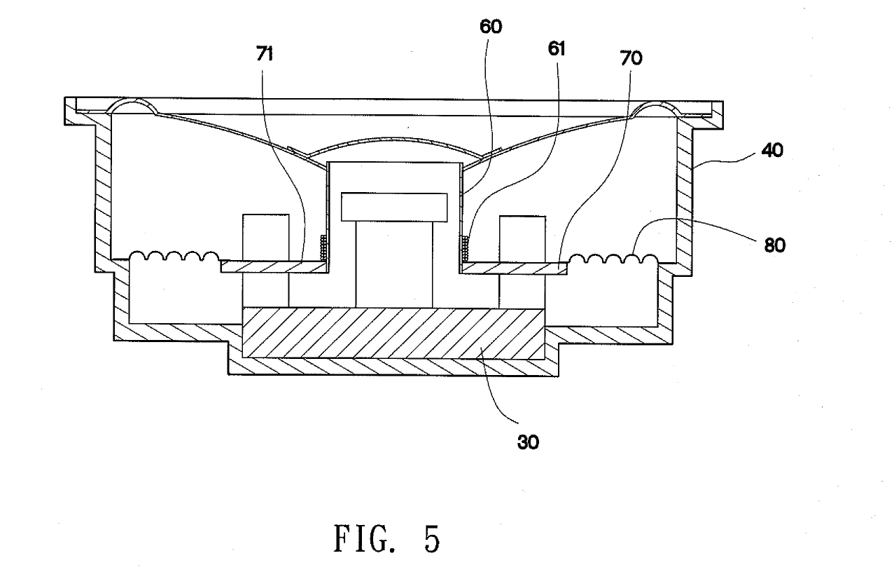

Referring to FIG. 5, a loudspeaker in accordance with a second preferred embodiment of the invention is shown. The second embodiment is identical to the first embodiment, except that the arms 71 of the bridge 70 are secured to a lower end of the voice coil 60 under the coil wires 61. This has the benefit of further lowering the center of gravity of the voice coil 60. As a result, the voice coil 60 is more stable when the loudspeaker is activating.

While the invention herein disclosed has been described by means of specific embodiments, numerous modifications and variations could be made thereto by those skilled in the art without departing from the scope and spirit of the invention set forth in the claims.

What is claimed is:

1. A loudspeaker comprising:
a substantially cylindrical frame having a top shoulder and an intermediate shoulder;
an annular voice coil having coil wires mounted on a lower portion, the coil wires having a heatproof adhesive coated thereon;
an annular U type spaced around the voice coil and secured to a bottom of the frame, the U type including a plurality of equally spaced radial channels;
a magnet on a center of the voice coil;
a washer on the magnet;
a bridge including a plurality of arms, each arm disposed through the channel and having one end secured to the coil wires;
a damper having a circumferential inner edge secured to the other ends of the arms and a circumferential outer edge secured to the intermediate shoulder of the frame;
a cone having a convex outer edge secured to the top shoulder of the frame and an inner edge secured to a top edge of the voice coil above the coil wires; and
a dust cap on a central portion of the cone above the voice coil.

2. The loudspeaker of claim 1, wherein a space defined by the frame is staged and is decreased in diameter toward its bottom.

3. The loudspeaker of claim 1, wherein the arms are secured to a bottom end of the coil wires.

4. The loudspeaker of claim 1, further comprising an annular member disposed around the U type and integrally formed with the other ends of the arms.
